(19) United States
(12) Patent Application Publication
(10) Pub. No.: US 2013/0114860 A1
(43) Pub. Date: May 9, 2013

(54) IN-VEHICLE IMAGE PROCESSING DEVICE

(71) Applicants: Masayuki Isaku, Tokyo (JP); Takafumi Yamamoto, Tokyo (JP)

(72) Inventors: Masayuki Isaku, Tokyo (JP); Takafumi Yamamoto, Tokyo (JP)

(73) Assignee: MITSUBISHI ELECTRIC CORPORATION, Tokyo (JP)

(21) Appl. No.: 13/810,811

(22) PCT Filed: Nov. 15, 2010
(86) PCT No.: PCT/JP2010/006695

§ 371 Date: Jan. 17, 2013

(51) Int. Cl. G06K 9/46

(52) U.S. Cl. CPC G06K 9/46
USPC 382/104

(57) ABSTRACT

An in-vehicle image processing device includes: movement distance detection units 2 and 73 which detect a movement distance of a vehicle; a movement distance determination unit 73 which determines whether or not the vehicle has moved a predetermined distance from an initial position based on the movement distance detected by the movement distance detection units 2 and 73; an unnecessary area identification unit 74 which obtains an inter-frame difference of an image picked up by an in-vehicle camera 1 by the time when the movement distance determination unit 73 determines that the vehicle has moved the predetermined distance from the initial position, and identifies an area, where a change amount of the image is not more than a threshold, as an unnecessary area; and an unnecessary area removal unit 77 which removes an image of the unnecessary area identified by the unnecessary area identification unit 74.

### TECHNICAL FIELD

The present invention relates to an in-vehicle image processing device that removes an image of an unnecessary area on an image picked up by an in-vehicle camera.

### BACKGROUND ART

Conventionally, there exists a system such that a camera is attached to the rear portion of a vehicle and that a rearward image picked up by the camera is displayed on a monitor when the vehicle is backed into a parking lot. With this system, a driver can easily back the vehicle into the parking lot with watching the rearward image displayed on the monitor.

In order to display surrounding information required to support the parking, a wide-angle lens is used in the camera. In addition, there are cases where the attachment position and angle of the camera are predetermined in order to display a guide line for supporting the parking on the picked-up rearward image. As a result, there is a possibility that a bumper or a license plate on the rear portion of the vehicle is shown in the image picked up by the camera. In this case, the bumper and the license plate are displayed on the monitor together with the surrounding information though they are unnecessary areas, which interferes with the support for the parking. Accordingly, it is desired to remove the image of the unnecessary areas.

In contrast, there exists an image processing device which masks the unnecessary area on the image (see, e.g., Patent Document 1). In the image processing device disclosed in Patent Document 1, only when the shift of a vehicle is in a reverse position during an operation other than an unloading operation, an image area other than an image area required for backing the vehicle is masked. Note that the area to be masked is preset as a fixed area.

### PRIOR ART DOCUMENTS

### Patent Documents

Patent Document 1: Japanese Patent Application Laid-open No. H7-205721

### SUMMARY OF THE INVENTION

### Problems to be Solved by the Invention

However, the position of the unnecessary area such as the bumper or the license plate differs depending on the attachment position and angle of the camera and the type of the vehicle. Therefore, in the method that fixes the masked area such as the image processing device disclosed in Patent Document 1, there is a problem such that the unnecessary area cannot be completely removed. In addition, there is another problem such that an area other than the unnecessary area is masked. Further, there is also a problem such that the unnecessary area has a complicated shape so that it is difficult for a user to remove the unnecessary area with simple procedures.

The present invention is made in order to solve the aforementioned problems, and an object of the invention is to provide an in-vehicle image processing device capable of easily identifying an unnecessary area on an image picked up by an in-vehicle camera and reliably removing the unnecessary area.

### Means for Solving the Problems

An in-vehicle image processing device according to the present invention includes: a movement distance detection unit which detects a movement distance of a host vehicle; a movement distance determination unit which determines whether or not the vehicle has moved a predetermined distance from an initial position based on the movement distance detected by the movement distance detection unit; an unnecessary area identification unit which performs an inter-frame difference of an image picked up by an in-vehicle camera by the time when the movement distance determination unit determines that the vehicle has moved the predetermined distance from the initial position, and identifies an area where a change amount of the image is not more than a threshold as an unnecessary area, and an unnecessary area removal unit which removes an image of the unnecessary area that is identified by the unnecessary area identification unit.

In addition, the in-vehicle image processing device according to the present invention includes an operation input unit which receives an input of information indicative of the unnecessary area on the image picked up by the in-vehicle camera, an unnecessary area identification unit which identifies the unnecessary area based on the information inputted via the operation input unit, and an unnecessary area removal unit which removes the image of the unnecessary area that is identified by the unnecessary area identification unit.

According to the present invention, since the device is thus configured, it is possible to easily identify the unnecessary area on the image picked up by the in-vehicle camera and reliably remove the unnecessary area.

### BRIEF DESCRIPTION OF THE DRAWINGS

FIG. 1 is a view showing a configuration of an in-vehicle image processing device according to Embodiment 1 in the present invention.

FIG. 2 is a view showing a configuration of a control unit in Embodiment 1 in the invention.

FIG. 3 is a view showing a rearward image picked up by a camera in Embodiment 1 in the invention.

FIG. 4 is a flowchart showing an unnecessary area identification operation by the in-vehicle image processing device according to Embodiment 1 in the invention.

FIG. 5 is a flowchart showing an unnecessary area removal operation by the in-vehicle image processing device according to Embodiment 1 in the invention.

FIG. 6 is a view for explaining removal of the unnecessary area (mask display) by the in-vehicle image processing device according to Embodiment 1 in the invention.

FIG. 7 is a view for explaining removal of the unnecessary area (mask display) by the in-vehicle image processing device according to Embodiment 1 in the invention.

FIG. 8 is a view for explaining removal of the unnecessary area (non-display) by the in-vehicle image processing device according to Embodiment 1 in the invention.

### BEST MODE FOR CARRYING OUT THE INVENTION

Hereinbelow, an embodiment of the present invention will be described in detail with reference to the accompanying drawings. Embodiment 1.

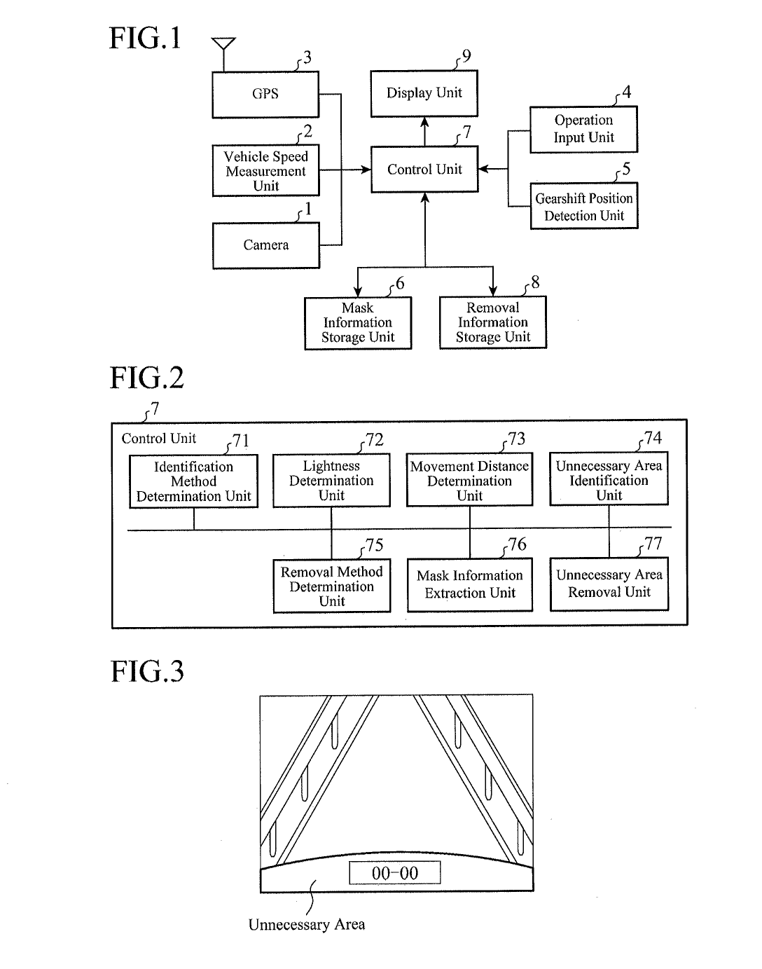

As shown in FIG. 1, an in-vehicle image processing device includes a camera 1, a vehicle speed measurement unit 2, a GPS (Global Positioning System) 3, an operation input unit 4, a shift position detection unit 5, a mask information storage unit 6, a control unit 7, a removal information storage unit 8, and a display unit (monitor) 9.

The camera 1 is attached to the rear portion of a vehicle, and picks up a rearward image. In order to display surrounding information required to support parking, a wide-angle les is used in the camera 1. In addition, in order to display a guide line for supporting the parking on the picked-up rearward image, the angle and position of attachment of the camera 1 are predetermined. Accordingly, as shown in FIG. 3, in the rearward image picked up by the camera 1, an unnecessary area such as a bumper or a license plate on the rear portion of the vehicle is also shown (only the license plate is shown in FIG. 3). The rearward image picked up by the camera 1 is outputted to the control unit 7.

The vehicle speed measurement unit 2 measures the speed of the vehicle. Information indicative of the vehicle speed measured by the vehicle speed measurement unit 2 is outputted to the control unit 7.

The GPS 3 acquires GPS information (vehicle position information, time information, or the like). The GPS information acquired by the GPS 3 is outputted to the control unit 7.

The operation input unit 4 receives the operation by a user, and includes a touch panel and the like. The operation input unit 4 receives the selection of an identification method of the unnecessary area (automatic identification and manual identification). Herein, when the manual identification is selected, the operation input unit 4 also receives the selection of a manual identification method (tracing specification and point specification).

In addition, the operation input unit 4 receives the selection of a removal method of the unnecessary area (mask display and non-display). Herein, when the mask display is selected, the operation input unit 4 also receives the selection of a masking method (a mask pattern, shape, and color) and the selection of a guide letter display position (upper portion display and lower portion display).

Various information items received by the operation input unit 4 are outputted to the control unit 7.

The shift position detection unit 5 detects the position of the shift of the vehicle. Herein, when the shift position detection unit 5 determines that the shift is switched to a reverse position, the shift position detection unit 5 requests the control unit 7 to display the rearward image.

The mask information storage unit 6 stores mask information such as a plurality of mask patterns used when the unnecessary area is masked (painting out, color changing, and mosaicking), a shape used in mosaicking, and a color used when the painting out or the color changing is performed. The mask information stored in the mask information storage unit 6 is extracted by the control unit 7.

The control unit 7 controls the individual units of the in-vehicle image processing device. The control unit 7 identifies the unnecessary area in the rearward image picked up by the camera 1, and removes the unnecessary area. The configuration of the control unit 7 will be described later.

The removal information storage unit 8 stores removal information (the unnecessary area, the removal method, the mask information, and the guide letter display position) from the control unit 7. The removal information stored in the removal information storage unit 8 is extracted by the control unit 7.

The display unit 9 displays the rearward image in which the image of the unnecessary area is removed by the control unit 7 and an operation guide screen according to the command by the control unit 7.

Next, the configuration of the control unit 7 will be described.

As shown in FIG. 2, the control unit 7 includes an identification method determination unit 71, a lightness determination unit 72, a movement distance determination unit 73, an unnecessary area identification unit 74, a removal method determination unit 75, a mask information extraction unit 76, and an unnecessary area removal unit 77.

The identification method determination unit 71 confirms the identification method of the unnecessary area selected by the user via the operation input unit 4. Herein, when the identification method determination unit 71 determines that the automatic identification of the unnecessary area is selected, the identification method determination unit 71 notifies the lightness determination unit 72 and the unnecessary area identification unit 74 of the determination.

On the other hand, when the identification method determination unit 71 determines that the manual identification of the unnecessary area is selected, the identification method determination unit 71 notifies the unnecessary area identification unit 74 of the determination. At this point, the identification method determination unit 71 also confirms the manual identification method selected by the user via the operation input unit 4, and notifies the unnecessary area identification unit 74 of the selected manual identification method.

The lightness determination unit 72 determines the present surrounding lightness (nighttime or daytime) when the identification method determination unit 71 determines that the automatic identification of the unnecessary area is selected. The lightness determination unit 72 determines the surrounding lightness based on the GPS information (time information) acquired by the GPS and the brightness of the rearward image picked up by the camera 1. Herein, when the lightness determination unit 72 determines that the present surrounding lightness is high (it is not nighttime), the lightness determination unit 72 notifies the unnecessary area identification unit 74 and the movement distance determination unit 73 of the determination.

The movement distance determination unit 73 determines whether or not the vehicle has moved a predetermined distance or more from its initial position after the lightness determination unit 72 determined that the present surrounding lightness was high. At this point, the movement distance determination unit 73 detects the movement distance of the vehicle based on the vehicle speed measured by the vehicle speed measurement unit 2. The vehicle speed measurement unit 2 and the movement distance determination unit 73 correspond to movement distance detection units of the preset application. In addition, the movement distance determination unit 73 presets a minimum movement distance, and optimizes the movement distance according to the vehicle speed. That is, as the vehicle speed becomes higher, the movement distance is set to be longer. Herein, when the movement distance determination unit 73 determines that the vehicle has moved the predetermined distance or more from the initial position, the movement distance determination unit 73 notifies the unnecessary area identification unit 74 of the determination.

The unnecessary area identification unit 74 identifies the unnecessary area in the rearward image picked up by the camera 1, and includes a RAM (Random Access Memory). When the identification method determination unit 71 determines that the automatic identification of the unnecessary area is selected, the unnecessary area identification unit 74 retains the rearward image picked up by the camera 1 until the movement distance determination unit 73 determines that the vehicle has moved the predetermined distance or more from the initial position after the lightness determination unit 72 determined that the present surrounding lightness was high. Subsequently, the unnecessary area identification unit 74 identifies the unnecessary area based on the retained rearward image from the initial position to the position after the movement. That is, the unnecessary area identification unit 74 obtains an inter-frame difference of the rearward image from the initial position to the position after the movement, and identifies an area where a change amount in the color or the brightness of the image is not more than a threshold as the unnecessary area.

In addition, when the identification method determination unit 71 determines that the manual identification of the unnecessary area is selected, the unnecessary area identification unit 74 acquires information indicative of the unnecessary area inputted by the user via the operation input unit 4 according to the manual identification method, and identifies the unnecessary area based on the information.

Information indicative of the unnecessary area identified by the unnecessary area identification unit 74 is outputted to the removal information storage unit 8.

The removal method determination unit 75 confirms the removal method selected by the user via the operation input unit 4. Herein, when the removal method determination unit 75 determines that the mask display is selected, the removal method determination unit 75 notifies the mask information extraction unit 76 and the unnecessary area removal unit 77 of the determination.

On the other hand, when the removal method determination unit 75 determines that the non-display is selected, the removal method determination unit 75 notifies the unnecessary area removal unit 77 of the determination.

In addition, information indicative of the removal method confirmed by the removal method determination unit 75 is also outputted to the removal information storage unit 8.

When the removal method determination unit 75 determines that the mask display is selected, the mask information extraction unit 76 extracts the corresponding mask information stored in the mask information storage unit 6 according to the masking method selected by the user via the operation input unit 4. The mask information extracted by the mask information extraction unit 76 is outputted to the unnecessary area removal unit 77 and the removal information storage unit 8.

The unnecessary area removal unit 77 removes the unnecessary area in the rearward image picked up by the camera 1. When the removal method determination unit 75 determines that the mask display is selected, the unnecessary area removal unit 77 masks the unnecessary area in the rearward image based on the mask information extracted by the mask information extraction unit 76 and the unnecessary area information stored in the removal information storage unit 8. At this point, the unnecessary area removal unit 77 corrects the display of the image based on the size of each of the masked area and a guide letter area and the guide letter display position selected by the user via the operation input unit 4. Information indicative of the guide letter display position confirmed by the unnecessary area removal unit 77 is outputted to the removal information storage unit 8.

On the other hand, when the removal method determination unit 75 determines that the non-display is selected, the unnecessary area removal unit 77 extends an area other than the unnecessary area on the image by an area corresponding to the unnecessary area to remove the image of the unnecessary area based on the unnecessary area information stored in the removal information storage unit 8.

The rearward image in which the unnecessary area is removed by the unnecessary area removal unit 77 is outputted to the display unit 9.

Next, a description will be given of an unnecessary area identification operation by the in-vehicle image processing device thus configured.

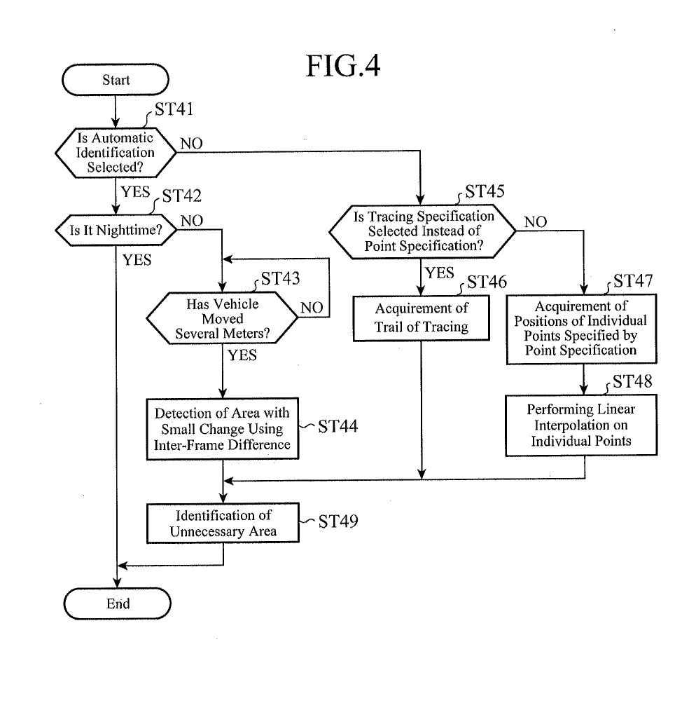

In the unnecessary area identification operation by the in-vehicle image processing device, as shown in FIG. 4, the identification method determination unit 71 first determines whether or not the automatic identification of the unnecessary area is selected by the user via the operation input unit 4 (Step ST41).

In Step ST41, when the identification method determination unit 71 determines that the automatic identification of the unnecessary area is selected, the lightness determination unit 72 determines whether or not it is presently nighttime (Step ST42).

In Step ST42, when the lightness determination unit 72 determines that it is presently nighttime, this sequence is ended. Herein, when the unnecessary area is identified using an inter-frame difference, there is a possibility that erroneous recognition occurs if it is nighttime and dark in a surrounding area. Therefore, the automatic identification of the unnecessary area is not performed at nighttime.

On the other hand, in Step ST42, when the lightness determination unit 72 determines that it is not presently nighttime, picking up of the rearward image by the camera 1 is started, and the unnecessary area identification unit 74 retains the rearward image. In a state where the rearward image is being picked up by the camera 1 in this manner, the user moves the vehicle.

Next, the movement distance determination unit 73 determines whether or not the vehicle has moved the predetermined distance or more from the initial position based on the vehicle speed measured by the vehicle speed measurement unit 2 (Step ST43). Note that the movement of the vehicle may be forward or backward movement. In addition, by setting the movement distance to a longer distance at high speed movement, the number of frames is increased and recognition accuracy is thereby improved.

In Step ST43, when the movement distance determination unit 73 determines that the vehicle has not moved the predetermined distance or more, the sequence returns to Step ST43 and a standby state is established.

On the other hand, in Step ST43, when the movement distance determination unit 73 determines that the vehicle has moved the predetermined distance, the unnecessary area identification unit 74 identifies the unnecessary area based on the retained rearward image from the initial position to the position after the movement (Steps ST44 and ST49). That is, the unnecessary area identification unit 74 obtains the inter-frame difference of the rearward image from the initial position to the position after the movement, and identifies the area where the change amount in the color or the brightness of the image is not more than the threshold as the unnecessary area. Note that the inter-frame difference is determined on the basis of a one-pixel unit or a block unit (e.g., 10×10 pixel).

In addition, the unnecessary area identification unit 74 changes the threshold for the change amount according to the vehicle speed measured by the vehicle speed measurement unit 2. That is, since the change of the image is extreme during the high speed movement, it is contemplated that the threshold is increased, so that a small change is neglected to thereby avoid an erroneous recognition. Further, it is assumed that the unnecessary area such as the bumper or the license plate is present in the lower portion of the image, and therefore the identification of the unnecessary area is performed only on the lower portion of the image. With this, it is possible to avoid the erroneous recognition, thereby reducing calculation time thereof.

In this manner, when the following characteristic is used: the unnecessary area such as the bumper or the license plate moves together with the camera 1,and therefore the change of the image is small even when the vehicle moves, the change of the image is detected by the inter-frame difference to thereby identify easily the unnecessary area. However, the above processing is performed at background processing, and it is not necessary to display the rearward image on the display unit 9.

On the other hand, in Step ST41, when the identification method determination unit 71 determines that the manual identification of the unnecessary area is selected by the user via the operation input unit 4, the identification method determination unit 71 determines whether or not the tracing specification is selected by the user via the operation input unit 4 (Step ST45).

In Step ST45, when the identification method determination unit 71 determines that the tracing specification is selected, the unnecessary area identification unit 74 acquires a trail of tracing by the user via the operation input unit 4, and identifies the unnecessary area based on the trail (Steps ST46 and ST49). Herein, the user traces a boundary between a necessary area and the unnecessary area via the operation input unit 4 while watching the rearward image displayed on the display unit 9. At this point, it is assumed that the area traced by the user is indented, and therefore the unnecessary area identification unit 74 corrects the acquired trail to be smooth. Then, it is assumed that the unnecessary area is present in the lower portion of the image, and hence the unnecessary area identification unit 74 identifies the area below the corrected trail as the unnecessary area. In such a way, it is possible for the user to easily identify the unnecessary area only by tracing the boundary. In addition, even when the traced trail is indented, the trail is automatically corrected; thus, the user does not need to perform a fine adjustment.

On the other hand, in Step ST45, when the identification method determination unit 71 determines that the point specification is selected, the unnecessary area identification unit 74 acquires the positions of individual points that are point-specified by the user via the operation input unit 4 (Step ST47). Herein, the user point-specifies a plurality of points on the boundary between the necessary area and the unnecessary area via the operation input unit 4 while watching the rearward image displayed on the display unit 9.

Next, the unnecessary area identification unit 74 performs linear interpolation on the acquired individual points, and identifies the unnecessary area based on a trail obtained by the linear interpolation (Steps ST48 and ST49). Specifically, the unnecessary area identification unit 74 first performs a linear interpolation on the acquired individual points. Then, it is assumed that the trail obtained by the linear interpolation is indented, and therefore the unnecessary area identification unit 74 corrects the acquired individual points to be smooth. Then, it is assumed that the unnecessary area is present in the lower portion of the image, and therefore the area below the corrected trail is identified as the unnecessary area. In such a way, it is possible for the user to easily identify the unnecessary area by only specifying the plurality of points on the boundary. In addition, since the trail obtained by the linear interpolation is automatically corrected, the user does not need to perform a fine adjustment.

As mentioned above, the user can intuitively determine the unnecessary area by manually performing the tracing specification or the point specification with the operation input unit 4.

By the above processing, it is possible to easily identify the unnecessary area shown in the image picked up by the camera 1. Note that the information indicative of the unnecessary area identified by the unnecessary area identification unit 74 is stored in the removal information storage unit 8.

Next, a description will be given of an unnecessary area removal operation by the in-vehicle image processing device thus configured.

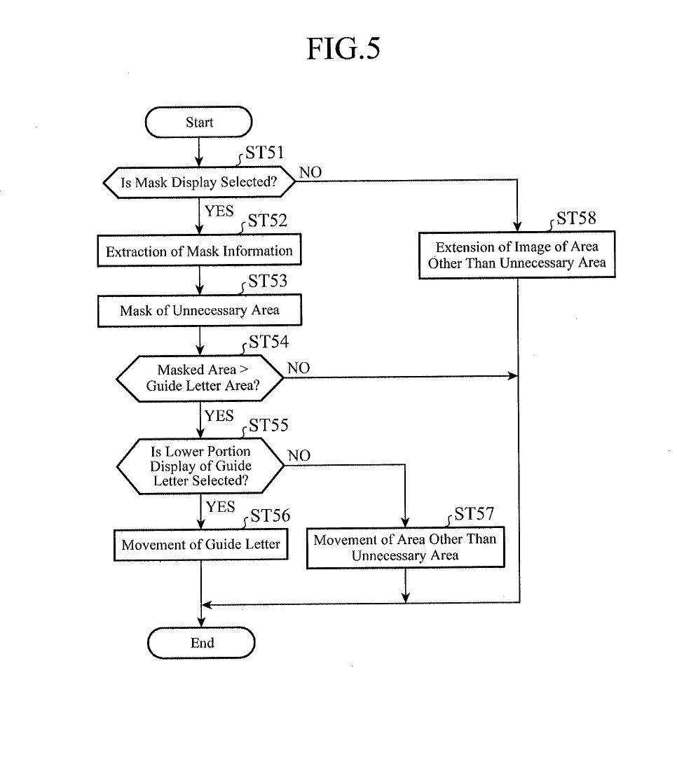

In the unnecessary area removal operation by the in-vehicle image processing device, when the shift position detection unit 5 determines that the shift of the vehicle is switched to the reverse position and requests the display of the rearward image, as shown in FIG. 5, the removal method determination unit 75 first determines whether or not the mask display is selected by the user via the operation input unit 4 (Step ST51).

In Step ST51, when the removal method determination unit 75 determines that the mask display is selected, the mask information extraction unit 76 extracts the corresponding mask information stored in the mask information storage unit 6 according to the masking method (the mask pattern, shape, and color) selected by the user via the operation input unit 4 (Step ST52). The mask information extracted by the mask information extraction unit 76 is outputted to the unnecessary area removal unit 77.

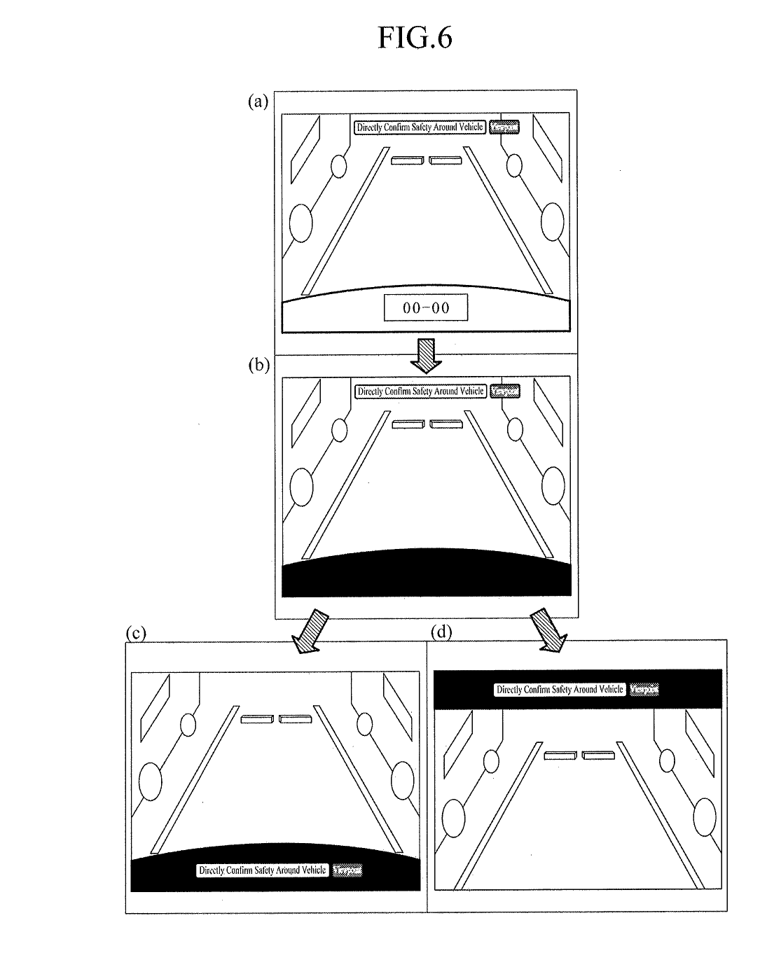

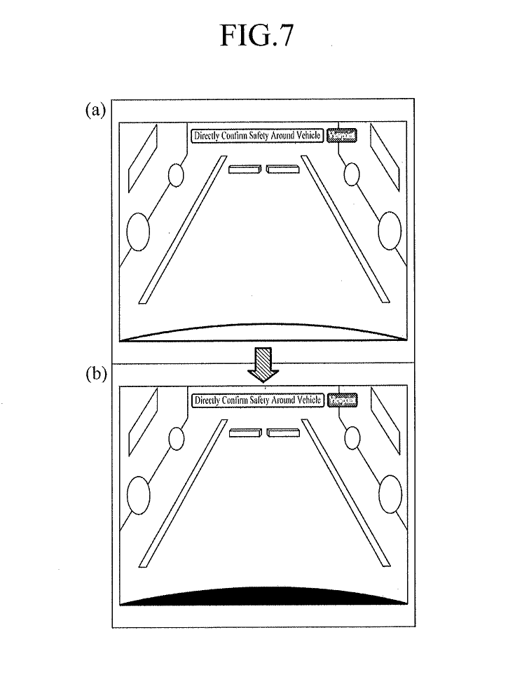

Next, the unnecessary area removal unit 77 masks the unnecessary area on the image based on the mask information extracted by the mask information extraction unit 76 and the unnecessary area information stored in the removal information storage unit 8 (Step ST53). With this, as shown in FIG. 6(b), it is possible to mask the unnecessary area in the rearward image.

Subsequently, the unnecessary area removal unit 77 determines whether or not the masked area is larger than the guide letter area (Step ST54).

In Step ST54, when the unnecessary area removal unit 77 determines that the masked area is smaller than the guide letter area, the sequence is ended. Thereafter, the rearward image in which the image of the unnecessary area is removed by the unnecessary area removal unit 77 is displayed on the display unit 9. For example, as shown in FIG. 7(b), when the masked area is smaller than the guide letter area, the display of the image is not corrected and the image is displayed without change.

On the other hand, in Step ST54, when the unnecessary area removal unit 77 determines that the masked area is larger than the guide letter area, the unnecessary area removal unit 77 determines whether or not the lower portion display of the guide letter is selected by the user via the operation input unit 4 (Step ST55).

In Step ST55, when the unnecessary area removal unit 77 determines that the lower portion display of the guide letter is selected, the unnecessary area removal unit 77 moves the guide letter onto the masked area in the lower portion (Step ST56). Thereafter, the sequence is ended and the rearward image in which the image of the unnecessary area is removed by the unnecessary area removal unit 77 is displayed on the display unit 9. In this manner, as shown in FIG. 6(c), the rearward image can be displayed without hid by the guide letter to thereby improve visibility thereof.

On the other hand, in Step ST55, when the unnecessary area removal unit 77 determines that the upper portion display of the guide letter is selected, the unnecessary area removal unit 77 moves the image of the area other than the unnecessary area downward by the height of the unnecessary area (Step ST57). Thereafter, the sequence is ended and the rearward image in which the image of the unnecessary area is removed by the unnecessary area removal unit 77 is displayed on the display unit 9. In this manner, as shown in FIG. 6(d), it is possible to display the rearward image without covering the rearward image with the guide letter to improve visibility thereof.

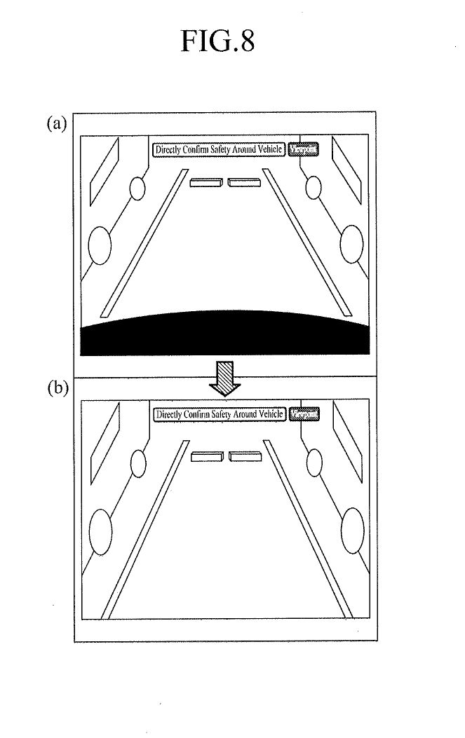

On the other hand, in Step ST51, when the removal method determination unit 75 determines that the non-display is selected, the image of the area of the rearward image other than the unnecessary area is extended by the height of the unnecessary area based on the unnecessary area information stored in the removal information storage unit 8 (Step ST58). That is, the image of the unnecessary area is not displayed, and the image of the area other than the unnecessary area is extended and displayed. Thereafter, the sequence is ended and the rearward image in which the image of the unnecessary area is removed by the unnecessary area removal unit 77 is displayed on the display unit 9. In this manner, as shown in FIG. 8(b), it is possible to widely display the surrounding information to improve visibility thereof.

Note that the removal method confirmed by the removal method determination unit 75, the mask information extracted by the mask information extraction unit 76, and the guide letter display position information confirmed by the unnecessary area removal unit 77 are stored in the removal information storage unit 8.

Hereafter, when the removal of the unnecessary area is performed, the removal of the unnecessary area is performed by extracting the mask information (the unnecessary area, the removal method, the mask information, and the guide letter display position) stored in the removal information storage unit 8.

As described above, according to Embodiment 1 of the present invention, since the configuration is adopted in which the vehicle is moved while the rearward image is picked up by the in-vehicle camera 1, the presence or absence of the change of the image is grasped by the inter-frame difference of the rearward image, and the area having the small change amount is identified as the unnecessary area, it is possible to easily identify the unnecessary area in the image picked up by the camera 1 and reliably remove the unnecessary area. In addition, since it is configured that when the unnecessary area is manually identified, the unnecessary area is identified based on the information obtained by the tracing specification or the point specification by the user, it is possible for the user to remove the unnecessary area with a simple procedure.

It is noted that although in Embodiment 1 it is described that the unnecessary area is identified by the tracing specification or the point specification in the manual identification, but the invention is not limited thereto, and, for example, the unnecessary area may also be identified such that a contrast difference on the rearward image picked up by the camera 1 is used.

In this case, the operation input unit 4 receives the specification of a plurality of points within the unnecessary area in the vicinity of the boundary between the necessary area and the unnecessary area by the user. In addition, the unnecessary area removal unit 77 acquires the positions of the individual points that are point-specified by the user in the point specification via the operation input unit 4. Then, the unnecessary area identification unit 74 compares the brightness at each acquired point with the surrounding brightness to detect the boundary on which the brightness difference between them is not less than a threshold. Subsequently, an area below the boundary is identified as the unnecessary area.

Additionally, although Embodiment 1 is described on the assumption that the camera 1 is attached to the rear portion of the vehicle and the rearward image is picked up, the invention is not limited thereto, and the invention is applicable to, e.g., a camera which picks up a forward or lateral image.

However, in the present invention, within th scope of the invention, an arbitrary component in the embodiment can be modified or an arbitrary component in the embodiment can be omitted.

### INDUSTRIAL APPLICABILITY

The in-vehicle image processing device according to the present invention is capable of easily identifying the unnecessary area on the image picked up by the in-vehicle camera and also reliably removing the unnecessary area, and is suitable for use in the in-vehicle image processing device or the like which processes the image picked up by the in-vehicle camera.

### EXPLANATION OF REFERENCE NUMERALS

1 camera, 2 vehicle speed measurement unit, 3 GPS, 4 operation input unit, 5 shift position detection unit, 6 mask information storage unit, 7 control unit, 8 removal information storage unit, 9 display unit (monitor), 71 identification method determination unit, 72 lightness determination unit, 73 movement distance determination unit, 74 unnecessary area identification unit, 75 removal method determination unit, 76 mask information extraction unit, 77 unnecessary area removal unit

1. An in-vehicle image processing device which removes an image of an unnecessary area on an image picked up by an in-vehicle camera,
the device comprising:
a movement distance detection unit which detects a movement distance of a host vehicle;
a movement distance determination unit which determines whether or not the vehicle has moved a predetermined distance from an initial position based on the movement distance detected by the movement distance detection unit;
an unnecessary area identification unit which performs an inter-frame difference of the image picked up by the in-vehicle camera by the time the movement distance determination unit determines that the vehicle has moved the predetermined distance from the initial position, and identifies an area where a change amount of the image is not more than a threshold as the unnecessary area; and
an unnecessary area removal unit which masks the unnecessary area identified by the unnecessary area identification unit to remove the image of the unnecessary area.

2. An in-vehicle image processing device which removes an image of an unnecessary area on an image picked up by an in-vehicle camera,
the device comprising:
an operation input unit which receives an input of information indicative of the unnecessary area on the image picked up by the in-vehicle camera;
an unnecessary area identification unit which identifies the unnecessary area based on the information inputted via the operation input unit; and
an unnecessary area removal unit which masks the unnecessary area identified by the unnecessary area identification unit to remove the image of the unnecessary area.

3. The in-vehicle image processing device according to claim 2, wherein
the operation input unit receives a tracing specification of a boundary between a necessary area and the unnecessary area, and
the unnecessary area identification unit identifies the unnecessary area based on a traced trail via the operation input unit.

4. The in-vehicle image processing device according to claim 2, wherein
the operation input unit receives a specification of a plurality of points on a boundary between a necessary area and the unnecessary area, and
the unnecessary area identification unit interpolates the individual points specified via the operation input unit and identifies the unnecessary area based on a trail obtained by the corresponding interpolation.

5. The in-vehicle image processing device according to claim 2, wherein
the operation input unit receives a specification of a plurality of points in a vicinity of a boundary between a necessary area and the unnecessary area, and
the unnecessary area identification unit compares the brightness of each of the points specified via the operation input unit with the brightness around the corresponding each point to detect a boundary on which a brightness difference is not less than a threshold and identifies the unnecessary area based on the boundary.

6. (canceled)

7. (canceled)

8. The in-vehicle image processing device according to claim 1, wherein the unnecessary area removal unit extends an area other than the unnecessary area that is identified by the unnecessary area identification unit by an area corresponding to the unnecessary area in size.

9. The in-vehicle image processing device according to claim 2, wherein the unnecessary area removal unit extends an area other than the unnecessary area that is identified by the unnecessary area identification unit by an area corresponding to the unnecessary area in size.
